(19) United States
(12) Patent Application Publication
(10) Pub. No.: US 2011/0134342 A1
(43) Pub. Date: Jun. 9, 2011

(54) LIGHTING DEVICE, DISPLAY DEVICE AND TELEVISION RECEIVER

(75) Inventor: Yuki Horiguchi, Osaka-shi (JP)

(73) Assignee: SHARP KABUSHIKI KAISHA, Osaka-shi, Osaka (JP)

(21) Appl. No.: 13/054,793

(22) PCT Filed: Jun. 8, 2009
(86) PCT No.: PCT/JP2009/060435

§ 371 Date: Jan. 19, 2011

(30) Foreign Application Priority Data
Jul. 24, 2008 (JP) 2008-191236

(51) Int. Cl. H04N 5/66; G02F 1/13357; F21V 21/15

(52) U.S. Cl. 348/739; 349/61; 362/220; 348/E05.133

(57) ABSTRACT

A backlight unit 12 includes a cold cathode tube 17, a chassis 14, a stand 19, a cold cathode tube holder 18 and a rotor 26. The cold cathode tube 17 includes electrodes at ends and a luminescent material sealed therein. The chassis 14 includes a bottom plate 14a arranged on an opposite side from a light output side with respect to the cold cathode tube 17, and houses the cold cathode tube 17. The stand holds the chassis 14 such that a plate surface of the bottom plate 14a is set along the vertical direction. The cold cathode tube holder 18 holds the cold cathode tube 17 in a position parallel to the plate surface the bottom plate 14a. The rotor 26 rotates the cold cathode tube 17 around an axis perpendicular to the plate surface of the bottom plate 14a with respect to the chassis 14.

### TECHNICAL FIELD

The present invention relates to a lighting device, a display device and a television receiver.

### BACKGROUND ART

A known liquid crystal display device requires a backlight unit separately from a liquid crystal panel used therein because the liquid crystal panel does not emit light. The backlight unit is arranged behind the liquid crystal panel. A number of cold cathode tubes are arranged parallel to each other in a chassis that has an opening on the liquid crystal panel side. Each cold cathode tube includes a glass tube with electrodes at ends and mercury sealed therein as a luminescent material. The mercury is in a liquid state at room temperature.

In the liquid crystal display device, the liquid crystal panel having a rectangular shape is held by a stand such that a display screen (or a flat surface of a bottom plate of the chassis) are set along the vertical direction. However, the display screen may be rotated to change the position between portrait and landscape depending on the intended use. Specifically, the liquid crystal panel may be set in the portrait position in which a long dimension of the display screen lies in the vertical direction, or may be set in the landscape position in which the long dimension lies in the horizontal direction. If the backlight unit in which the cold cathode tubes are arranged such that the axes thereof are aligned along the long dimension of the display screen is set in the portrait position, the axes of the cold cathode tubes lay vertically. As a result, the mercury in each cold cathode tube in the liquid state at room temperature when the cold cathode tube is not lit concentrates around the electrode located at a lower side because of the gravity. This may cause problems such as reductions in luminescent efficiency while the cold cathode tubes are lit and in product lifetime.

A liquid crystal display device disclosed in Patent Document 1 is provided as an example that can solve the above problems. It includes a U shape cold cathode tubes that are mounted such that electrodes are not present at a lower side whether a liquid crystal panel is set in the portrait position or the landscape position.

Patent Document 1: Japanese Published Patent Application No. 2006-153954

### Problem to be Solved by the Invention

The technology disclosed in Patent Document 1 uses the U-shaped cold cathode tubes, electrodes of which are located on one side. Namely, it cannot be applied to a liquid crystal display device (or a backlight device and a television receiver) including straight-tube-type cold cathode tubes, electrodes of which are located on both side. The technology of Patent Document 1 can be applied to certain types of cold cathode tubes and extended application to liquid crystal display devices (or backlight devices and television receivers) having unacceptable configurations cannot be expected.

### DISCLOSURE OF THE PRESENT INVENTION

The present invention was made in view of the foregoing circumstances. An object of the present invention is to provide a configuration that does not limit types of usable discharge tubes and with which light-emitting efficiency and product lifetime are less likely to be reduced.

### Means for Solving the Problem

A lighting device of the present invention includes at least one discharge tube, a chassis, a chassis support member, at least one discharge tube holder and a rotor. The discharge tube has electrodes at ends thereof and a luminescent material sealed therein. The chassis has a bottom plate on an opposite side from a light output side with respect to the discharge tube and houses the discharge tube. The chassis support member holds the chassis such that a plate surface of the bottom plate is set along a vertical direction. The discharge tube holder holds the discharge tube in a position parallel to the plate surface of the bottom plate. The rotor is configured to rotate the discharge tube around an axis perpendicular to the plate surface of the bottom plate with respect to the chassis.

The chassis of the lighting device is held by the chassis support member such that the plate surface of the bottom plate is set along the vertical direction. The chassis may be held in a position such that a side of the bottom plate lies in the vertical direction or in a position such that the side lies in the horizontal direction depending on the intended use.

In either position regardless of the chassis position, the discharge tube is always maintained in a position such that the axis thereof is set in the horizontal direction by rotating the discharge tube around an axis perpendicular to the plate surface of the bottom plate with the rotor. Therefore, the luminescent material in the discharge tube is less likely to concentrate around the electrode. As a result, the light emitting efficiency or the lifetime of the discharge tube is less likely to be reduced.

The discharge tube is always in the position such that the axis thereof is set along the horizontal direction by rotating it with the rotor. Therefore, not only a discharge tube having electrodes on one side such as a U-shaped discharge tube but also a discharge tube having electrodes on both sides such as a straight-tube-type discharge tube can be used. Namely, any type of discharge tubes can be used.

### BRIEF DESCRIPTION OF THE DRAWINGS

FIG. 1 is an exploded perspective view illustrating a general construction of a television receiver according to a first embodiment of the present invention;

FIG. 2 is a cross-sectional view of a liquid crystal display device along the short side thereof;

FIG. 3 is a front view of the liquid crystal display device;

FIG. 4 is a rear view of the liquid crystal display device;

FIG. 5 is a magnified cross-sectional view illustrating a detailed configuration of a cold cathode tube holder;

FIG. 6 is a cross-sectional view of the cold cathode tube holder in FIG. 5 along line vi-vi;

FIG. 7 is a plan view of a chassis set in a landscape position;

FIG. 8 is a plan view of the chassis set in a portrait position;

FIG. 9 is a magnified cross-sectional view illustrating the cold cathode tube holder before a cold cathode tube is mounted;

FIG. 10 is a cross-sectional view of the cold cathode tube holder in FIG. 9 along line x-x;

FIG. 11 is a magnified cross-sectional view illustrating a detailed configuration of a cold cathode tube holder according to a second embodiment of the present invention;

FIG. 12 is a cross-sectional view of the cold cathode tube holder in FIG. 11 along line xii-xii;

FIG. 13 is a magnified cross-sectional view illustrating a detailed configuration of a cold cathode tube holder according to a third embodiment of the present invention;

FIG. 14 is a plan view of a chassis set in a landscape position according to a fourth embodiment of the present invention; and

FIG. 15 is a plan view of the chassis set in a portrait position.

### BEST MODE FOR CARRYING OUT THE INVENTION

### First Embodiment

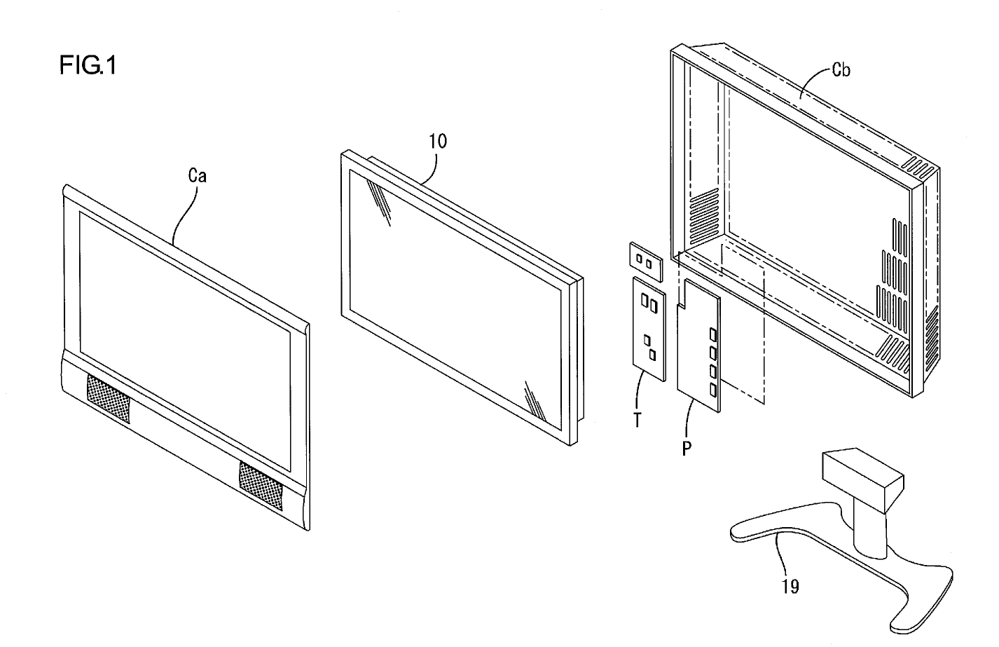

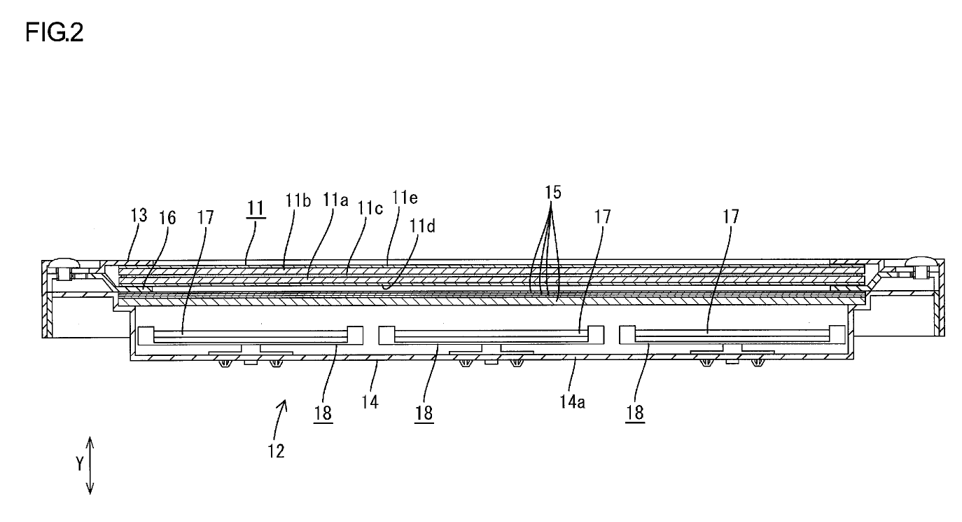

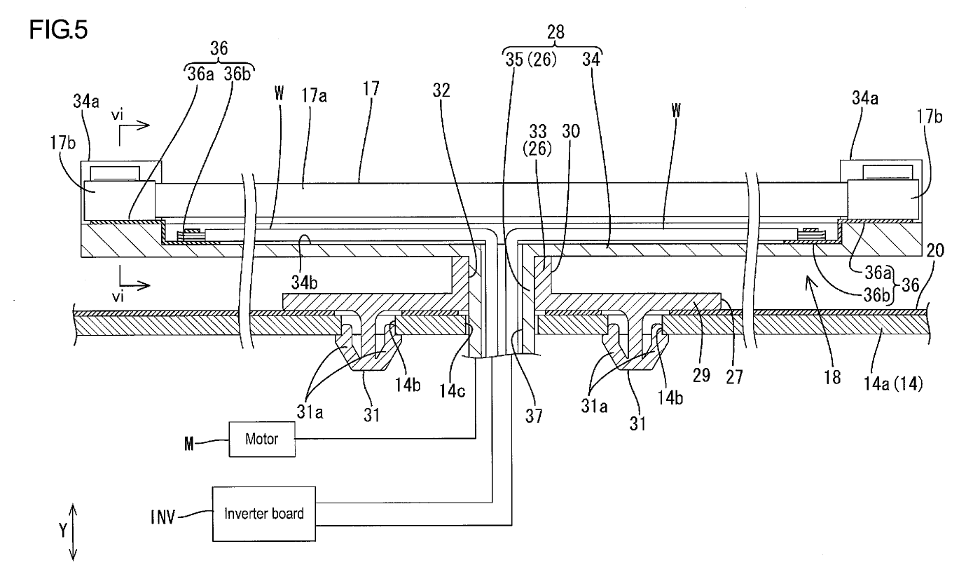

The first embodiment of the present invention will be explained with reference to FIGS. 1 to 10. In this embodiment, a liquid crystal display device 10 including a liquid crystal panel 11 will be explained. X-axes, Y-axes and Z-axes in some figures indicate directions in those figures. The X-axes and the Z-axes in those figures indicate the horizontal direction and the vertical direction, respectively. The top and the bottom in FIGS. 2 and 5 correspond to the front and the rear of the liquid crystal display device 10, respectively.

As illustrated in FIG. 1, a television receiver TV of this embodiment includes the liquid crystal display device 10 (a display device), front and rear cabinets Ca, Cb that house the liquid crystal display device 10 therebetween, a power source P and a tuner T. An overall shape of the liquid crystal display device 10 is a landscape rectangular. As illustrated in FIG. 2, the liquid crystal panel 11, which is a display panel, and the backlight unit 12 (a lighting device), which is an external light source, are held together by a bezel 13.

Next, the liquid crystal panel 11 and the backlight unit 12 included in the liquid crystal display device 10 will be explained. As illustrated in FIG. 2, the liquid crystal panel 11 has a liquid crystal layer 11c sealed between a pair of glass substrates 11a and 11b that are bonded together with a predetermined gap therebetween. On one of the glass substrate 11a, switching components (e.g., TFTs) connected to source lines and gate lines that are perpendicular to each other, pixel electrodes connected to the switching components and an alignment film are provided. On the other glass substrate, a color filter having red (R), green (G) and blue (B) color sections arranged in a predetermined matrix, a counter electrode and an alignment film are provided. Image data that is necessary for displaying an image and various control signals are sent from a drive circuit (not shown) to the source lines, the gate lines and the counter electrode. Polarizing plates 11d and 11e arranged on the outer surfaces of the glass substrates 11a and lib, respectively.

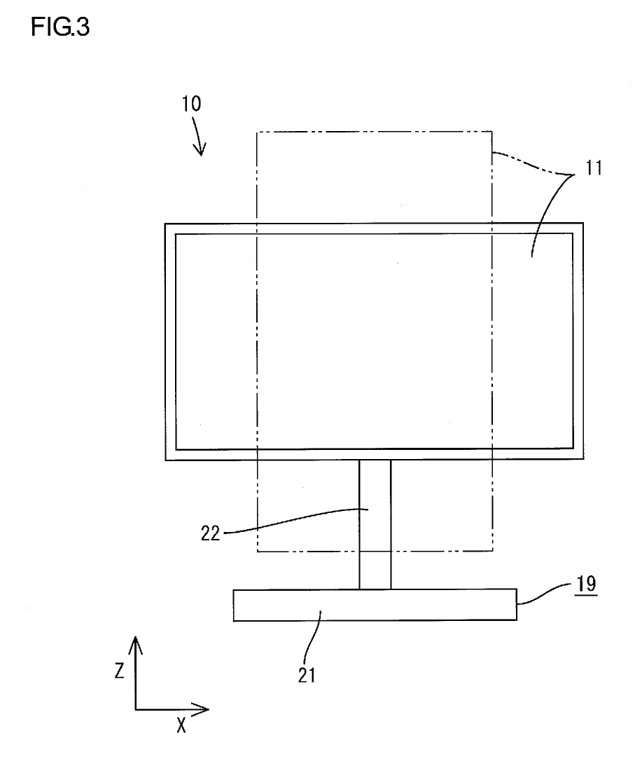

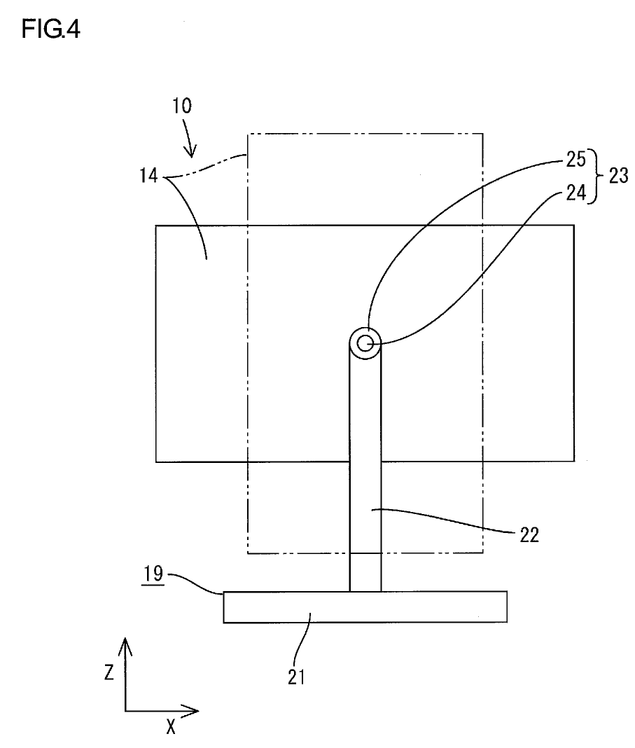

As illustrated in FIG. 2, the backlight unit 12 includes a chassis 14, an optical member 15, a frame 16, cold cathode tubes 17 and cold cathode tube holders 18. The chassis 14 has a landscape rectangular overall shape and an opening in a surface on the light output side (i.e., on the liquid crystal panel 11 side). The optical member 15 having a plate shape is attached to the chassis 14 so as to cover the opening. The optical member 15 is held between the chassis 14 and the frame 16. The cold cathode tubes 17 are light sources arranged between the bottom plate 14a of the chassis 14 and the optical member 15. The cold cathode tube holders 18 hold the cold cathode tubes 17. The cold cathode tube 17 and the cold cathode tube holders 18 are arranged in a matrix inside the chassis 14, which will be explained in detail later. As illustrated in FIGS. 3 and 4, a stand 19 is mounted to the rear surface of the chassis 14 (the surface opposite from the light output side) to hold the chassis 14 such that the bottom plate 14a of the chassis 14, the optical member 15 and the plate surface of the liquid crystal panel 11 are held in the vertical position (along the Z-axis direction).

The chassis 14 is made of metal, for example, aluminum. Side plates stand upright from respective edges of the bottom plate 14a having a rectangular shape in plan view similar to the liquid crystal panel 11. The bottom plate 14a is arranged behind the cold cathode tubes 17 so as to face the cold cathode tubes 17. Namely, it is arranged on a side opposite from the light output side with respect to the cold cathode tubes 17. A reflection sheet 20 is attached to the inner surface of the chassis 14 (see FIG. 5). The reflection sheet 20 reflects light from the cold cathode tubes 17 toward the optical member 15.

As illustrated in FIGS. 3 and 4, the stand 19 includes a base 21 and a post 22 that rises vertically from the base 21. The base 21 is placed directly on an installation surface in an installation area of the liquid crystal display device 10. The post 22 is attached to the bottom plate 14a of the chassis via a chassis rotor 23. The chassis rotor 23 includes a rotor shaft 24 and a rotor shaft receiver 25. The rotor shaft 24 has a substantially cylindrical shape and projects from the rear surface of the bottom plate 14a of the chassis 14. The rotor shaft receiver 25 is provided at the top end portion of the post 22 of the stand 19 for receiving the rotor shaft 24. The axes of the rotor shaft 24 and the rotor shaft receiver 25 are aligned along a direction perpendicular to the plate surface of the bottom plate 14a of the chassis 14 (i.e., the Y-axis direction). The chassis 14 can be rotated relative to the stand 19 with the chassis rotor 23 around the axis thereof perpendicular to the plate surface of the bottom plate 14a of the chassis 14. Namely, the chassis 14 can be rotated with the plate surface of the bottom plate 14a is maintained in the vertical position. The chassis 14 is held either in the landscape position in which the long dimension of the chassis 14 lies in the horizontal direction (illustrated with solid lines in FIGS. 3 and 4) or in the portrait position in which the long dimension of the chassis 14 lies in the vertical direction (illustrated with two-dot chain lines in FIGS. 3 and 4). The long-side direction and the short-side direction of the chassis 14 match the long-side direction and the short-side direction of the liquid crystal panel 11, respectively. The liquid crystal display device 10 further includes a sensor such as a gyro sensor (not shown) and thus whether the chassis 14 is in the portrait position or the landscape position can be determined.

“The plate surface of the bottom plate 14a of the chassis 14 is in the vertical position” does not mean that the bottom plate 14a of the chassis 14 is strictly parallel to the vertical direction. It means that the bottom plate 14a is in a position relatively closer to the vertical position than the horizontal position. For example, the bottom plate 14a may lean 0 to 45 degrees, preferably 0 to 30 degrees.

As illustrated in FIG. 2, the optical member 15 has a rectangular shape in plan view similar to the chassis 14 and the liquid crystal panel 11. The optical member 15 is made of synthetic resin capable of light transmission and arranged between the cold cathode tubes 17 and the liquid crystal panel 11. The cold cathode tubes 17 are arranged on the rear side and the liquid crystal panel 11 is arranged on the front side. The Optical member 15 includes a diffuser plate, a diffuser sheet, a lens sheet and a brightness enhancement sheet in this order from the rear side. It has a function of converting light emitted from each cold cathode tube 17 to a uniform planar light.

The frame 16 has a frame shape. The peripheral edges of the optical member 15 are held between the opening edges of the chassis 14 and the frame 16 so as to hold the components of the optical member 15 in layers.

The cold cathode tubes 17 are one kind of discharge tubes. As illustrated in FIG. 5, each of them includes an elongated glass tube 17a having a circular cross section, a pair of electrodes (not shown) and ferrules 17b. The ends of the glass tube 17a are sealed. The electrodes are enclosed in the glass tube 17a and located at the respective ends of the glass tube 17a. The ferrules 17b are put on (or fitted onto) the respective ends of the glass tube 17a. The cold cathode tube 17 is a so-called straight-tube-type cold cathode tube that includes a straight glass tube 17a and electrodes arranged at two different locations (left and right sides in FIG. 2). The glass tube 17a encloses a luminescent material such as mercury and a fluorescent material applied to the inner surface thereof. The electrodes and the ferrules 17a are made of metal having electrical conductivity. Parts of the cold cathode tube 17 at the ends on which the ferrules 17b are put on are non-light-emitting areas. A middle part of the glass tube 17a between the non-light-emitting areas (where the fluorescent material is applied) is a light-emitting area. Lead terminals (not shown) extend from the respective electrodes to outsides of the glass tube 17a. When the lead terminals are connected to the ferrules 17b, the electrodes and the ferrules 17a are at the same potential.

Each cold cathode tube holder 18 of this embodiment has a function of holding the cold cathode tube 17 parallel to the plate surface of the bottom plate 14a. It also has a function of rotating the cold cathode tube 17 within the chassis 14 and a rotor 26 for the rotation. The configuration of each cold cathode tube holder 18 will be explained in detail.

As illustrated in FIG. 5, each cold cathode tube holder 18 includes a fixed part 27 and a movable part 28. The fixed part 27 is fixed to the chassis 14 in the mounting position. The cold cathode tube 17 is mounted to the movable part 28. The fixed part 27 and the movable part 28 are made of resin. The fixed part 27 includes a mounting base portion 29 and rising portions 30. The mounting base portion 29 is arranged along the bottom plate 14a of the chassis 14. The rising portions 30 rise from the mounting base portion 29 toward the front, that is, to an opposite side from the bottom plate 14a side of the chassis 14 (i.e., on the optical member 15 side). The mounting base portion 29 has a plate shape substantially elongated rectangular in plan view. A pair of mounting portions 31 inserted in respective mounting holes 14b formed as through holes in the bottom plate 14a of the chassis 14 (and reflection sheet 20) project from the rear surface of the mounting base portion 29. Elastic stoppers 31a of each mounting portion 31 are pressed against an edge of the mounting hole 14a with elastic forces. As a result, the fixed part 27 is fixed to the bottom plate 14a.

The rising portion 30 has a substantially cylindrical shape with the axis thereof lying in the Y-axis direction and arranged around the midpoint of the long dimension of the mounting base portion 29. The rising portion 30 has a shaft hole 32 that is a through hole and concentric with the rising portion 30. The shaft hole 32 continues into the mounting base portion 29 and opens to the outside. The shaft hole 32 has a substantially circular shape in plan view and an inner rim thereof forms a part of a shaft receiving portion 33 for receiving the rotor shaft 35, which will be explained next.

The movable part 28 includes a cold cathode tube mounting portion 34 and a rotor shaft 35. The cold cathode tube 17 is mounted to the cold cathode tube mounting portion 34. The rotor shaft 35 projects from the cold cathode tube mounting portion 34 toward the rear, that is, projects toward the bottom plate 14a of the chassis 14. The cold cathode tube mounting portion 34 is formed in an elongated substantially rectangular column shape along the axial direction of the cold cathode tube 17. The length thereof is slightly larger than that of the cold cathode tube 17. Connecting terminals 36 are attached to ends of the cold cathode tube mounting portion 34. The connecting terminals 36 are provided for electrically connecting the cold cathode tube 17 to an inverter board INV (an external circuit for supplying power to the cold cathode tube 17). The connecting terminals 36 are fixed to the cold cathode tube mounting portion 34 in the mounting position with a fixing structure (not shown).

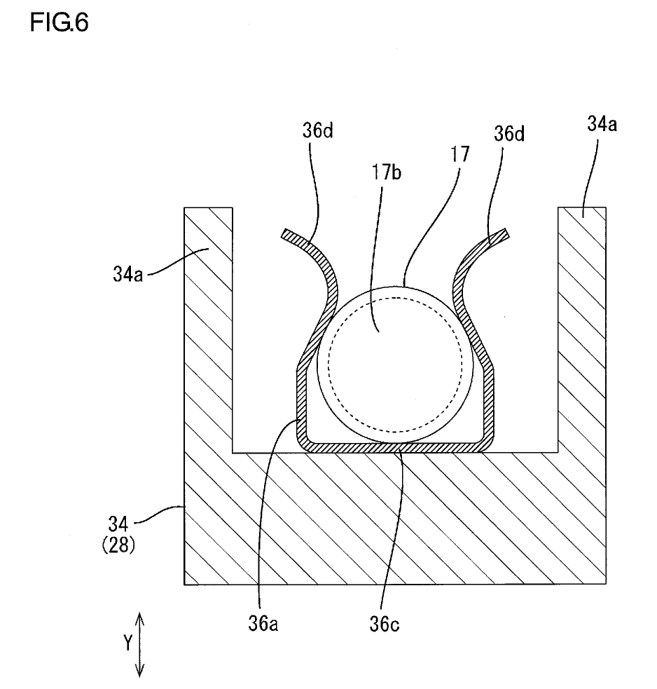

Each connecting terminal 36 is prepared by pressing a metal plate. It includes a ferrule contact portion 36a and a wire connecting portion 36b. The ferrule contact portion 36a is in contact with the ferrule 17b of the cold cathode tube 17 with electrical connection. The wire connecting portion 36b is connected to a wire W that is connected to the inverter board INV. As illustrated in FIG. 6, the ferrule contact portion 36a includes a pair of elastic contact arms 36d that rise from respective side edges of a base 36c along the Y-axis direction. When the cold cathode tube 17 is inserted between the elastic contact arms 36d, the ferrule 17b is brought in elastic contact with the elastic contact arms 36d. As a result, the cold cathode tube 17 is electrically connected to the connecting terminal 36. Moreover, the cold cathode tube 17 is indirectly and mechanically held to the movable part 28. Protection walls 34a for protecting the ferrule contact portion 36a rise from the ends of the cold cathode tube mounting portion 34. As illustrated in FIG. 5, each wire connecting portion 36b is provided a step below the ferrule contact portion 36a by cranking a part of the base 36c, and has a pair of crimp pieces that rise from the respective edges of the base 36c. The electrical connection between the connecting terminal and the wire W is made by crimping the crimp pieces onto a bare wire at the end of the wire W. In the middle section of the cold cathode tube mounting portion 34, a recess 34b is provided. The wire connecting portions 36b and the wires W are placed in the recess 34b. The wires W are laid along the recess 34b.

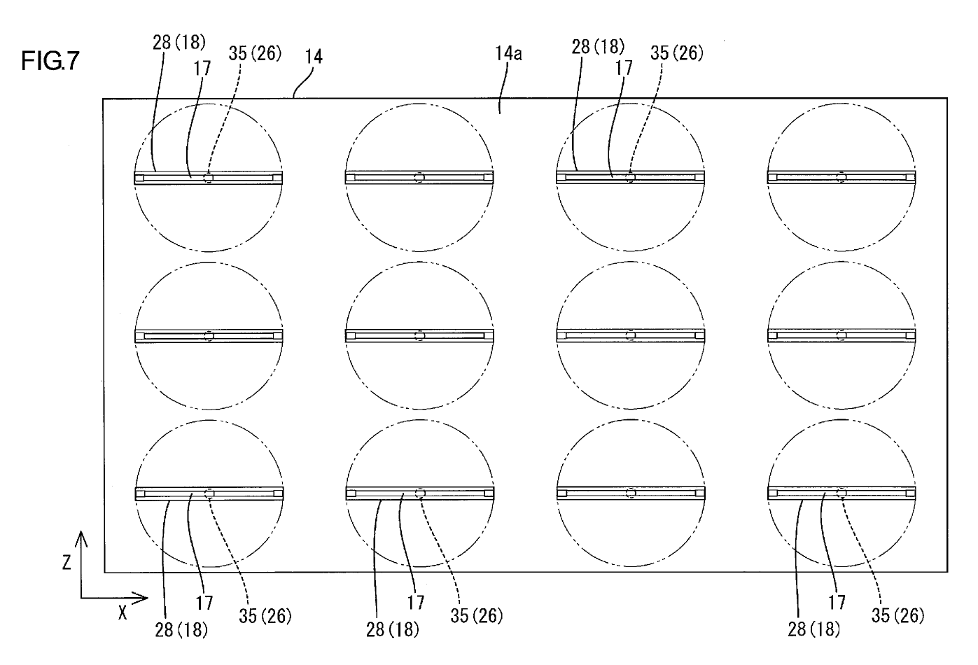

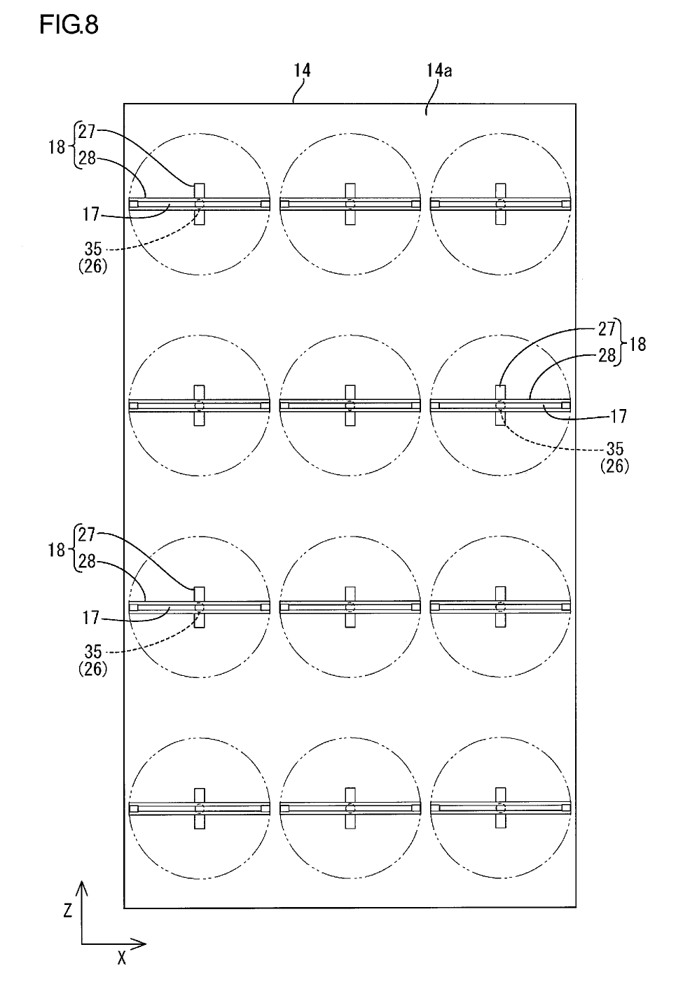

As illustrated in FIG. 5, the rotor shaft 35 has a substantially cylindrical shape, the axis of which lies along the Y-axis direction. It is arranged around the midpoint of the cold cathode tube mounting portion 34 in the length direction. Namely, the rotor shaft 35 is located around the midpoint of the cold cathode tube 17 in the axial direction. The outer diameter of the rotor shaft 35 is substantially equal to or slightly smaller than the inner diameter of the shaft hole 32 of the fixed part 27. The rotor shaft 35 is inserted in the shaft hole 32 of the fixed part 27 from the front side and fitted. The rotor shaft 35 is held with the inner wall of the shaft hole 32, which is the shaft receiving portion 33. As a result, the movable part 28 can rotate around the rotor shaft 35 and the shaft receiving portion 33 that extend along the Y-axis, and make relative rotary movement to the fixed part 27. Because the cold cathode tube 17 is integrally held with the movable part 28, it also can be rotated according to the rotary movement of the movable part. The rotation locus of the movable part 28 is circular (indicated by two-dot chain lines in FIGS. 7 and 8). Because the rotor shaft 35 is arranged around the midpoint of the movable part 28 and the cold cathode tube 17 in the length direction, the diameter of the rotation locus of the movable part 28 is substantially equal to the length of the movable part 28. Compared to a configuration in which the rotor shaft 35 is arranged off the midpoint of the movable part 28 and the cold cathode tube 17, the diameter of the rotation locus is as small as possible.

The length of the rotor shaft 35 is defined larger than the sum of the height of the fixed part 27 (i.e., the size measures in the Y-axis direction) and the thickness of the bottom plate 14a of the chassis 14. An insertion hole 14c, which is a thorough hole, is formed at midpoint between the mounting holes 14b in the bottom plate 14a of the chassis 14 (and the reflection sheet 20). A motor M, which is a power source, is mechanically connected to a part of the rotor shaft 35 projecting from the rear surface of the chassis 14 via a power transmission mechanism, such as a cam mechanism (not shown). When the motor M is driven, the power is transmitted to the rotor shaft 35 as a torque via the power transmission mechanism for rotating the rotor shaft 35 around the axis. The movable part 28 is mechanically supported by the power transmission mechanism. Therefore, the movable part 28 and the cold cathode tube 17 are held at specified positions with respect to the bottom plate 14a of the chassis 14 in the Y-axis direction.

The chassis 14 of this embodiment is held by the stand 19 so as to be movable by the chassis rotor 23. Whether the chassis 14 is in the portrait position or the landscape position is detected by the sensor and a detection result is fed back to the motor M. The motor M is driven associated with the position of the chassis 14. Therefore, the movable part 28 is controlled so that the length directions (i.e., the axial directions) of the cold cathode tube mounting portion 34 and the cold cathode tube 17 always lay in the horizontal direction (i.e., the X-axis direction) whether the chassis 14 is in the portrait position or the landscape position.

The rotor shaft 35 has a wire hole 37, which is a concentric through hole. The wire hole 37 continues into the cold cathode tube mounting portion 34 and to the outside. It continues into a holding recess 34b of the cold cathode tube mounting portion 34 and the wires W laid along the recess 34b are passed through the wire hole 37. The wires W passed through the wire hole 37 are arranged around the axis of the rotor shaft 35 and thus less likely to be twisted when the movable part 28 is rotated. The wire hole 37 is formed in a substantially circular shape in plan view.

As illustrated in FIGS. 3, 7 and 8, the lengths of each cold cathode tube 17 and cold cathode tube holder 18 are defined shorter than the short side and the long side of the chassis 14. A plurality of the cold cathode tubes 17 and the cold cathode tube holders 18 are arranged in a matrix inside the chassis 14. Specifically, twelve cold cathode tubes 17 and twelve cold cathode tube holders 18, four in a row along the long side of the chassis 14 and three in a column along the short side of the chassis 14, are arranged at specified intervals. The cold cathode tubes 17 and the cold cathode tube holders are arranged such that the rotation loci of movable parts 28 (indicated with the two-dot chain lines in FIGS. 7 and 8) around the respective rotor shafts 35 do not overlap each other. The fixed part 27 of each cold cathode tube holder 18 is fixed to the bottom plate 14a such that the length direction thereof matches the long-side direction of the chassis 14.

The operation of this embodiment having the above configuration will be explained. During the assembly of the backlight unit 12, the fixed parts 27 of the cold cathode tube holders 18 are fixed to the bottom plate 14a of the chassis 14 at specified locations. The rotor shafts 35 of the movable parts 28 are fitted in the respective shaft holes from the front side and the top ends thereof are mechanically connected to the power transmission mechanism. As a result, each movable part 28 is held in the specified position with respect to the bottom plate 14a of the chassis 14 in the Y-axis direction. The connecting terminals 36 are connected to each movable part 28. The wires W are laid along the recesses 34b and passed through the wire hole 37. They are electrically connected to the inverter board INV.

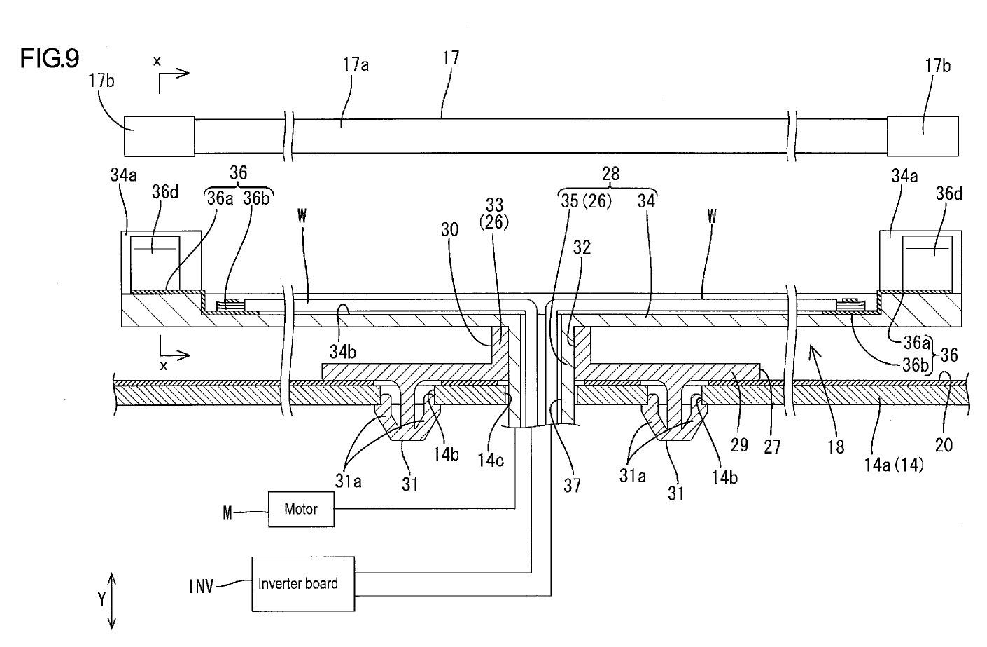

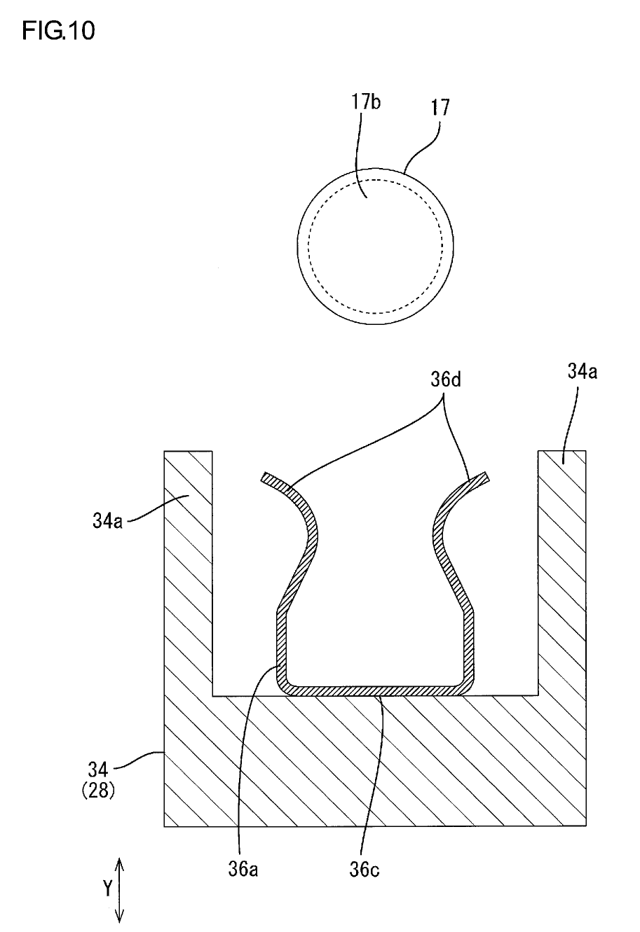

Then, the cold cathode tubes 17 are mounted to the respective movable parts 28. As illustrated in FIGS. 9 and 10, the ferrules 17b at the respective ends of each cold cathode tube 17 are positioned so as to correspond to the ferrule contact portions 35a of the respective connecting terminals 36. Then, the cold cathode tube 17 is fitted to the movable part 28 from the front side. When each ferrule 17b passes between the elastic contact arms 36d, the elastic contact sections 36d opens with elastic deformation. When the ferrule 17b is pushed to the proper position, it is electrically connected to the connecting terminal 36 and the cold cathode tube 17 is mechanically held with the connecting terminal 36 as illustrated in FIGS. 5 and 6. As a result, the cold cathode tube 17 is integrally held with the movable part 28 of the cold cathode tube holder 18 via the connecting terminal 36. Then, the optical member 15, the frame 16 and the stand 19 are mounted in sequence and the assembly of the backlight unit 12 is complete. The assembled backlight unit 12 and the liquid crystal panel 11 are held together with the bezel 13. The production of the liquid crystal display device 10 is complete.

To set the liquid crystal display device 10 such that the chassis 14 and the liquid crystal panel 11 are in the landscape position, the long dimensions of the chassis 14 and the liquid crystal panel 11 are aligned along the horizontal direction (i.e., the X-axis direction). In this condition, the axis of the cold cathode tube 17 lays in the horizontal direction.

To change the positions of the chassis 14 and the liquid crystal panel 11 from the landscape position to the portrait position, the chassis 14 and the liquid crystal panel 11 are rotated around the axes of the rotor shaft 24 and the shaft receiving portion 25 of the chassis rotor 23 by 90 degrees with respect to the stand 19. The chassis 14 and the liquid crystal panel 11 are set in the portrait position indicated by the two-dot chain lines in FIGS. 3 and 4 while the bottom plate 14a of the chassis 14 is maintained along the vertical direction. In the portrait position, the long dimensions of the chassis 14 and the liquid crystal display panel 11 are aligned along the vertical direction (i.e., the Z-axis direction).

When the chassis 14 and the liquid crystal panel 11 are rotated and changed from the landscape positions to the portrait positions, the position change is detected by a gyro sensor. The detection result is fed back from the sensor to the motor M. As a result, the motor M is driven and the rotor shafts 35 are rotated in the shaft receiving portions 33 via the power transmission mechanism. Each movable part 28 and the corresponding cathode tube 17 are rotated relatively to the corresponding fixed part 27 and the chassis 14. When the cold cathode tubes 17 and the movable parts 28 are rotated by about 90 degrees, the motor M stops. As illustrated in FIG. 8, the cold cathode tubes 17 are set in a position such that the axes thereof is aligned along the horizontal direction. When changing the positions of the chassis 14 and the liquid crystal panel 11 from portrait to landscape, the motor M is driven in the same manner as the above. As a result the movable parts 28 and the cold cathode tubes 17 are rotated, and the cold cathode tubes 17 are set in a position such that the axes thereof are aligned along the horizontal direction as illustrated in FIG. 7.

Whether the chassis 14 is in the portrait position or the landscape position, the cold cathode tubes 17 are maintained in a position such that the axes thereof are set along the horizontal direction because of the rotor 26. When the liquid crystal display panel 10 is not in use and the cold cathode tubes 17 are not lit, the luminescent materials such as mercury in the cold cathode tubes are in the liquid state. Even under such a condition, the luminescent material is about evenly distributed in each cold cathode tube 17. Namely, the luminescent material does not concentrate near either one of the electrodes. When the liquid crystal display device 10 is in use and the cold cathode tubes 17 are lit, the luminescent material evenly distributed in each glass tube 17a is properly vaporized and produce luminescence with preferable luminescent efficiency. Therefore, the lifetime of the cold cathode tube 17 improves.

As described the above, the backlight unit 12 of this embodiment includes the cold cathode tubes 17, the chassis 14, the stand 19, the cold cathode tube holders 18 and the rotors 26. Each cold cathode tube 17 includes the electrodes at the ends and the luminescent material sealed therein. The chassis 14 houses the cold cathode tubes 17 and has the bottom plate 14a on an opposite side from the light output side with respect to the cold cathode tubes 17. The stand 19 supports the chassis 14 such that the plate surface of the bottom plate 14a is aligned along the vertical direction. The cold cathode tube holders 18 hold the cold cathode tubes 17 in positions along the plate surface of the bottom plate 14a. The rotors 26 rotate the respective cold cathode tubes 17 around the axes perpendicular to the plate surface of the bottom plate 14a with respect to the chassis 14.

The chassis 14 included in the backlight unit 12 is held by the stand 19 such that the plate surface of the bottom plate 14a is set along the vertical direction. However, the chassis 14 may be set in a position such that on of the sides (e.g., the long side) of the bottom plate 14a is set along the vertical direction or along the horizontal direction depending on the intended use.

Even in such a case, the cold cathode tubes 17 can be set such that the axes thereof are always along the horizontal direction regardless of the position of the chassis 14 by rotating the cold cathode tubes 17 around the axes perpendicular to the plate surface of the bottom plate 14a with respect to the chassis 14 using the rotors 26. With this configuration, the luminescent material in each cold cathode tube 17 is less likely to concentrate around the electrodes. Therefore, the light-emitting efficiency or the product lifetime is less likely to be reduced.

By rotating the cold cathode tubes 17 with the rotors 26, the axes of the cold cathode tubes 17 are always set along the horizontal direction. This configuration allows not only the U-shaped cold cathode tubes having the electrodes on one side but also the straight-tube-type cold cathode tubes 17 having electrodes at either end to be used. Namely, any type of the cold cathode tubes 17 can be used.

According to this embodiment, any type of the cold cathode tubes 17 can be used. Moreover, the luminescent efficiency or the lifetime of the cold cathode tubes 17 is less likely to be reduced.

Each cold cathode tube holder 18 includes the fixed part 27 and the movable part 28. The fixed part 27 is mounted to the chassis 14 and fixed in the mounting position. The cold cathode tube 17 is mounted to the movable part 28. Each rotor 26 includes the rotor shaft 35 and the shaft receiving portion 33. The rotor shaft 35 is provided in the movable part 28 and the shaft receiving portion 33 is provided in the fixed part 27. The shaft receiving portion 33 receives the rotor shaft 35. With the shaft receiving portion 33, the movable part 28 can make relative rotary movement to the fixed part 27. With this configuration, the cold cathode tube 17 can be rotated by rotating the movable part 28 to which the cold cathode tube 17 is mounted relatively to the fixed part 27 that is fixed to the chassis 14. Because the rotor shaft 35 is received by the shaft receiving portion 33 provided in the fixed part 27 or the movable part 28, stable rotary movement is possible.

Because the motor M, which is a power source, is mechanically connected to each rotor shaft 35, each cold cathode tube 17 can be rotated with the power supplied by the motor M.

The wires W are connected to the respective electrodes of each cold cathode tube 17. The wires W are connected to the inverter board INV, which is an external circuit. Each rotor shaft 35 has the wire insertion hole 37, which is a through hole and concentric with the rotor shaft 35, for pulling the wires W out. Because the wires W are passed through the wire insertion hole 37 formed as a through hole and concentric with the rotor shaft 35, they are less likely to be twisted even when the cold cathode tube 17 is rotated.

The ferrules 17b are fitted onto the ends of each cold cathode tube 17. The ferrules 17b are connected to the electrodes. The wire connecting portions 36 are mounted to each cold cathode tube holder 18. Each wire connecting portion 36 includes the wire connecting section 36b at one end and the ferrule contact section 36a at the other end. The wire W is connected to the wire connecting section 36b. The ferrule contact section 36a is electrically connected to the ferrule 17b. This configuration is suitable for the cold cathode tube 17 having the ferrules 17b.

The rotation center of the rotor 26 is located around the midpoint of the cold cathode tube 17 in the axial direction. With this configuration, only small space is required for rotating the cold cathode tube 17. Therefore, the inner space of the chassis 14 can be conserved.

The cold cathode tube 17 is a straight-tube type. Because the straight-tube-type cold cathode tube is widely used in comparison to a curved-tube-type cold cathode tube, it can be easily available and thus contributes to a cost reduction.

The cold cathode tubes 17 and the cold cathode tube holders 18 are arranged in matrixes on the bottom plate 14a of the chassis 14. Even the chassis 14 is large, the cold cathode tubes 17 can be evenly arranged in an entire area within the inner space of the chassis 14. Therefore, this configuration is suitable for the liquid crystal display device 10 in a large size.

The chassis rotor 23 is provided in the stand 19 and chassis 14. The chassis rotor 23 rotates the chassis 14 around the axis perpendicular to the plate surface of the bottom plate 14a with respect to the stand 19. With this configuration, the position of the chassis 14 can be easily changed between the portrait position and the landscape position. In the portrait position, one of the sides (i.e., the long side) of the bottom plate 14a is set in the vertical direction. In the landscape position, one of the sides (i.e., the long side) of the bottom plate 14a is set in the horizontal direction.

The liquid crystal display device 10 of this embodiment includes the backlight unit 12 and the liquid crystal panel 11. The liquid crystal panel 11 provides display using light from the backlight unit 12. According to the liquid crystal display device 10, the backlight unit 12 that illuminates the liquid crystal panel 11 does not have limitation on the types of the cold cathode tubes 17 and the luminescent efficiency or the lifetime of the cold cathode tubes 17 is less likely to be reduced. Therefore, high design flexibility, high display quality and long lifetime can be achieved. The liquid crystal display device 10 can be used for a television receiver and a personal computer display. It is especially suitable for large-screen applications. For example, it is suitable for information displays or advertisement displays installed in train stations or public facilities.

### Second Embodiment

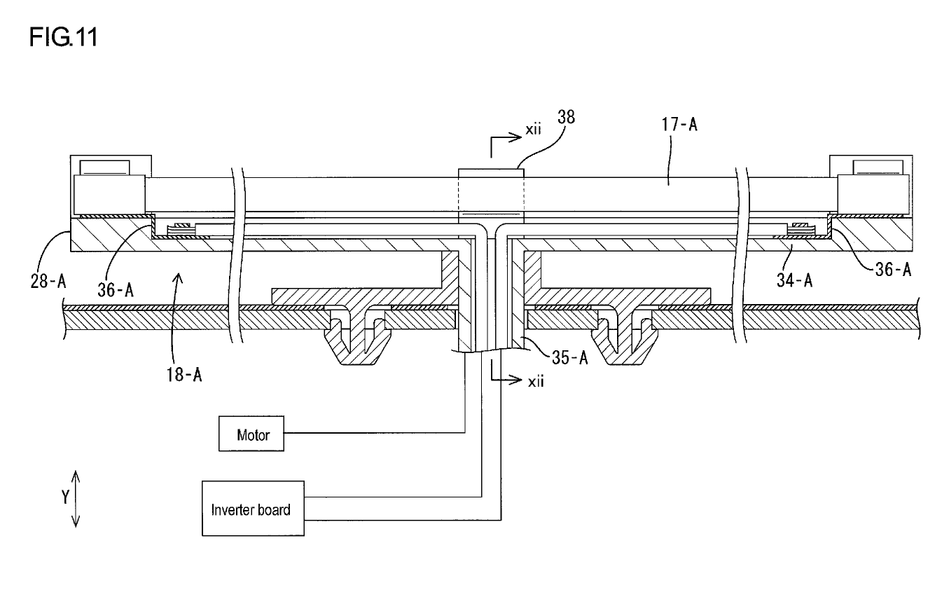

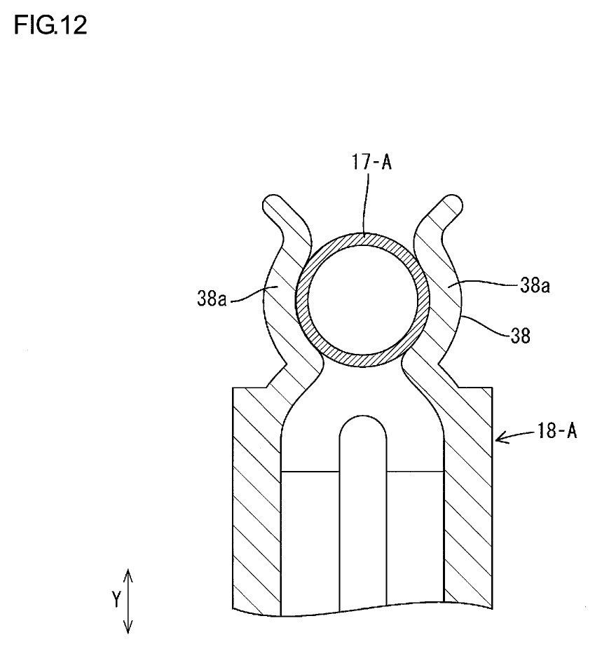

The second embodiment of the present invention will be explained with reference to FIGS. 11 and 12. In the second embodiment, a grip function for gripping a cold cathode tube 17-A is added to a cold cathode tube holders 18-A. Parts having the same structures as those of the parts in the first embodiment will be indicated by the same symbols followed by “-A.” The same structures, functions and effects will not be explained.

As illustrated in FIG. 11, a movable part 28-A of each cold cathode tube holder 18-A has a grip part 38 that can holds the cold cathode tube 17-A. The grip part 38 is located around the midpoint of a cold cathode tube mounting portion 34-A of the movable part 28-A in the length direction. Namely, it is located about the same position as a rotor shaft 35-A. It includes a pair of elastic grip arms 38a that rise from that location toward the front. As illustrated in FIG. 12, each elastic grip arm 38a has a cantilever shape and a curved shape so as to be along the periphery of the cold cathode tube 17-A. The elastic grip arms 38a open with elastic force generated during attachment or detachment of the cold cathode tube 17-A. A part of the cold cathode tube 17-A around the midpoint thereof in the axial direction is held with elastic force. Therefore, the cold cathode tube 17-A is indirectly held by the movable part 28-A via the connecting terminals 36-A and directly held by the grip part 38.

According to this embodiment, each cold cathode tube holder 18-A includes the grip part 38 that can hold the corresponding cold cathode tube 17-A. Therefore, the cold cathode tube 17-A can be stably held.

### Third Embodiment

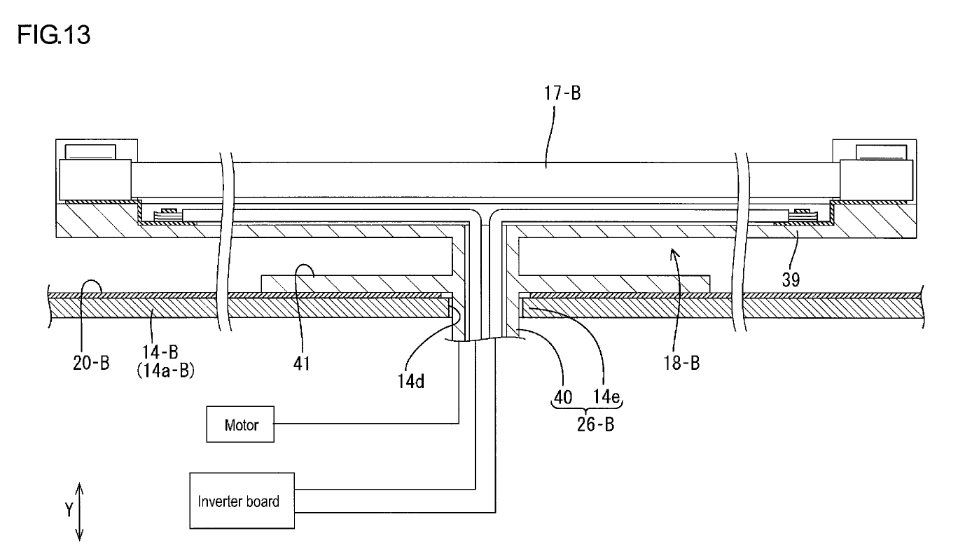

The third embodiment of the present invention will be explained with reference to FIG. 13. In this embodiment, each cold cathode tube holder 18-B has one-piece structure. Parts having the same structures as those of the parts in the first embodiment will be indicated by the same symbols followed by “-B.” The same parts, functions and effects will not be explained.

As illustrated in FIG. 13, each cold cathode tube holder 18-B includes a cold cathode tube mounting portion 39, a rotor shaft 40 and a flange 41. A cold cathode tube 17-B is mounted to the cold cathode tube mounting portion 39. The rotor shaft projects from the rear surface of the cold cathode tube mounting portion 39, that is, projects toward a bottom plate 14a-B of a chassis 14-B. The flange 41 projects from a part of the rotor shaft 40 and is placed against the bottom plate 14a-B of the chassis 14-B. The cold cathode tube mounting portion 39 has substantially the same structure as the cold cathode tube mounting portion 39 of the movable part 28 of the first embodiment. Therefore, it will not be explained in detail.

The rotor shaft 40 has a substantially cylindrical shape with the axis thereof lies along the Y-axis direction. It is arranged around the midpoint of the cold cathode tube mounting portion 39 in the length direction. Namely, the rotor shaft 40 is arranged around the midpoint of the cold cathode tube 17-B in the axial direction. The bottom plate 14a-B of the chassis 14-B (and a reflection sheet 20-B) has a shaft hole 14d that is a through hole into which the rotor shaft 40 is inserted from the front side. The shaft hole 14d has a substantially round shape and an inner diameter about the same as or slightly larger than the outer diameter of the rotor shaft 40. Therefore, the cold cathode tube holder 18-B can make relative rotary movement to the bottom plate 14a-B of the chassis 14-B with the rotor shaft 40 or a shaft receiving portion 14e as a center of the rotation. The rotor shaft 40 and the shaft receiving portion 14e extend along the Y-axis. Because the cold cathode tube 17-B is held integrally with the cold cathode tube holder 18-B, it also can be rotated according to the rotary movement of the cold cathode tube holder 18-B. The rotor shaft 40 is mechanically connected to the motor M via the power transmission mechanism and held at a predefined position with respect to the chassis 14-B, similarly to the first embodiment.

A position of the cold cathode tube holder 18-B with respect to the bottom plate 14a-B is defined by placing the flange 41 against the front surface of the bottom plate 14a-B of the chassis 14-B. The flange 41 has an elongated rectangular shape in plan view similar to the cold cathode tube mounting portion 39 with a length and a width smaller than those of the cold cathode tube mounting portion 39. When the cold cathode tube holder 18-B is rotated, the flange 41 is also rotated along with the cold cathode tube mounting portion 39. Therefore, the flange 41 is always completely hidden behind the cold cathode tube mounting portion 39 and is not viewed from the front.

As described the above, this embodiment has the following configurations. Each cold cathode tube holder 18-B includes the cold cathode tube mounting portion 39 and the rotor shaft 40. The cold cathode tube 17-B is mounted to the cold cathode tube mounting portion 39. The rotor shaft 40 projects from the cold cathode tube mounting portion 39 toward the bottom plate 14a-B of the chassis 14-B. The bottom plate 14a-B of the chassis 14-B has the shaft hole 14d into which the rotor shaft 40 is inserted. The rotor 26-B includes the rotor shaft 40 and the shaft receiving portion 14e. The shaft receiving portion 14e that are the rim of the shaft hole 14d receives the rotor shaft 40 and enables the relative rotary movement of the cold cathode tube holder 18-B to the chassis 14-B. With the configurations, the cold cathode tube 17-B can make the relative rotary movement to the bottom plate 14a-B of the chassis 14-B by rotating the cold cathode tube holder 18-B because it is mounted to the cold cathode tube mounting portion 39. Since the cold cathode tube holder 18-B has the one-piece structure, the number of parts and steps required for preparing it can be reduced in comparison to the first embodiment that has a two-piece structure. Namely, it is preferable for a cost reduction.

### Fourth Embodiment

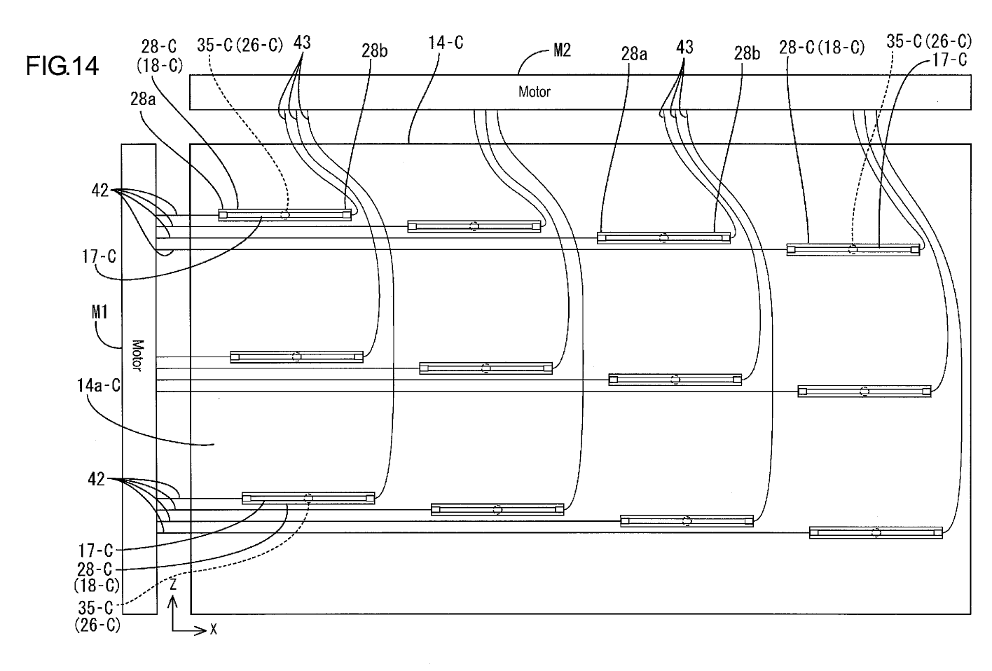

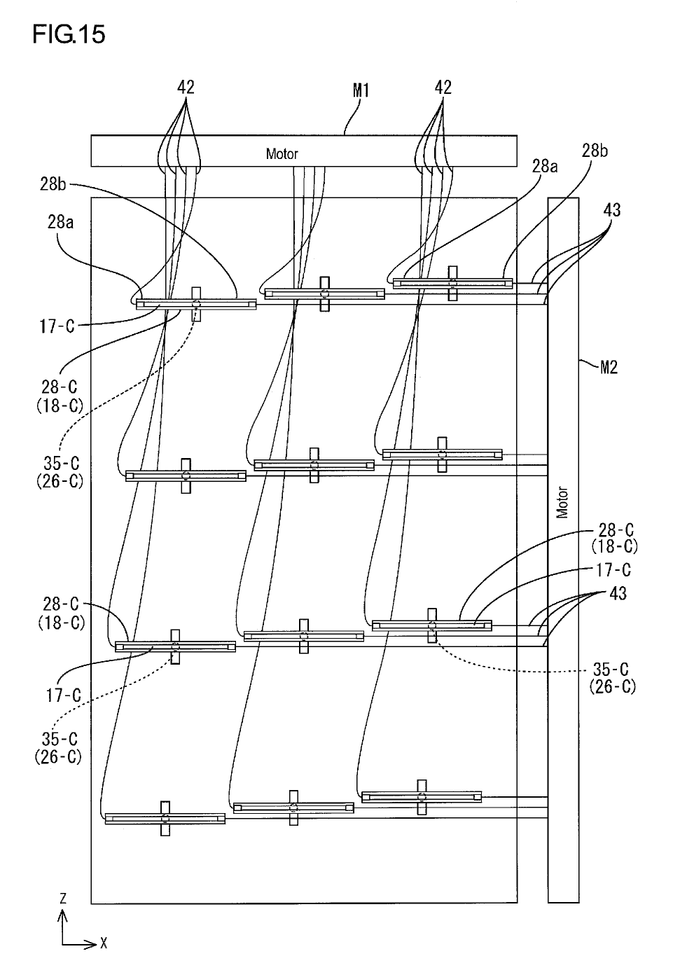

The fourth embodiment of the present invention will be explained with reference to FIGS. 14 and 15. In this embodiment, the power transmission mechanism in the first embodiment is modified. Parts having the same structures as those of the parts in the first embodiment will be indicated by the same symbols followed by “-C.” The same parts, functions and effects will not be explained.

As illustrated in FIG. 14, threadlike (or cordlike) power transmission members 42 and 43 are connected to a movable part 28-C of each cold cathode tube holder 18-C that holds a cold cathode tube 17-C. The power transmission members 42 and 43 are made of strong and less visible threadlike (or cordlike) material. One of ends of each power transmission member 42 or 43 is connected to an end 28a or 28b of the movable part 28-C of the cold cathode tube holder 18-C, that is, connected to the cold cathode tube holder 18-C at a position off the center of the rotation (i.e., the rotor shaft 35-C). The other end is connected to the motor M1 or M2.

The power transmission members 42 and 43 are connected to the motors M1 and M2, respectively. The first motor M1 is arranged along the short side of the chassis 14-C and the second motor M2 is arranged along the long side of the chassis 14-C. The power transmission members 42 and 43 include the first power transmission member 42 connected to the first motor M1 and the second power transmission member 43 connected to the second motor M2. As illustrated in FIG. 14, the first power transmission member 42 is connected to the left end of the movable part 28-C of the cold cathode tube holder 18-C (i.e., the first end 28a). The second power transmission member 43 is connected to the right end of the movable part 28-C (i.e., the second end 28b). Namely, the power transmission members 42 and 43 connected the motors M1 and M2, respectively, are connected to the respective ends 28a and 28b of the movable part 28. The cold cathode tube holders 18-C are arranged vertically and horizontally shifted from each other.

As illustrated in FIG. 14, when the chassis 14-C is in the landscape position, the first motor M1 rotates in a direction to reel the first power transmission member 42. The first end 28a of the movable section 28-C of the cold cathode tube holder 18-C is pulled with a specified tension. The second motor M2 rotates in a direction to loose the second power transmission member 43 or remains in neutral so that the second power transmission member 43 can be pulled out freely. With this configuration, the cold cathode tube 17-C and the movable part 28-C can be maintained in positions with the length direction thereof along the horizontal direction.

As illustrated in FIG. 15, when the chassis 14-C is in the portrait position, the second motor M2 rotates in a direction to reel the second power transmission member 43. The second end 28b of the movable part 28-C of the cold cathode tube holder 18-C is pulled with a specified tension. The first motor M1 rotates in a direction to loose the first power transmission member 42 or remains in neutral so that the first power transmission member 42 can be pulled out freely. With this configuration, the cold cathode tube 17-C and the movable part 28-C can be maintained in positions with the length direction thereof along the horizontal direction.

As described above, this embodiment has the following configurations. The cold cathode tube holders 18-C are arranged on the bottom plate 14a-C of the chassis 14-C either in rows or in columns. The power transmission members 42 and 43 connected to the motors M1 and M2, respectively, are connected to the corresponding cold cathode tube holder 18-C at positions off the center of the rotation of the rotor 26-C. The motors M1 and M2 are power sources. When the motor M1 and M2 are driven, the cold cathode tubes 17-C are rotated by the power transmitted through the power transmission members 42 and 43.

### Other Embodiments

The present invention is not limited to the above embodiments explained in the above description. The following embodiments may be included in the technical scope of the present invention, for example.

(1) The cold cathode tube holders, each of which includes the movable part having the rotor shaft and the fixed part having the shaft receiving portion, are explained in the first embodiment. However, the present invention can be applied to one including the rotor shaft in the fixed part and the shaft receiving section in the movable part.

(2) In the first and the fourth embodiments, each cold cathode tube holder is mounted to the chassis such that the length direction of the fixed part thereof matches the long-side direction of the chassis. However, cold cathode tube holders mounted such that the length direction of the fixed parts matches the short-side direction of the chassis may be included in the scope of the present invention.

(3) In the above embodiments, the center of the rotation of each rotor is set at a midpoint of the cold cathode tube in the axial direction. However, one having the center of the rotation at a point other than the midpoint may be included in the scope of the present invention.

(4) In the above embodiments, the cold cathode tubes having ferrules are used. However, a cold cathode tube having leads extend from ends of a glass tube without ferrules can be used. In this case, the connecting terminals of each cold cathode tube holder are not required and the wires are soldered to the leads of the cold cathode tube.

(5) In the above embodiments, the straight-tube-type cold cathode tubes are used. However, a curved-tube-type cold cathode tube having a curved glass tube in the middle section may be used. The curved-tube-type cold cathode tube may be formed in Z shape, U shape or W shape. The Z-shaped cold cathode tube has a pair of electrodes on different sides. The U-shaped or the W-shaped cold cathode tube has a pair of electrodes on one side. The Z-shape, the U-shape and the W-shaped cold cathode tubes can be used in one device.

(6) The cold cathode tubes are used in the above embodiments as discharge tubes. However, hot cathode tubes can be used. Moreover, other types of discharge tubes including sodium lamps, mercury lamps, metal halide lams and xenon lamps can be used.

(7) The number, the length or the arrangement of cold cathode tubes in the above embodiments may be changed.

(8) In the above embodiments, the chassis rotor for rotating the chassis with respect to the stand is explained. However, one without the chassis rotor may be included in the scope of the present invention. In this case, the liquid crystal display device is manufactured as either one of portrait-type liquid crystal display device and landscape-type liquid crystal display device. The backlight unit having the rotor can be used in either type. That is because the backlight device having the rotor can maintain the cold cathode tubes in the horizontal position whether the chassis is in the portrait position or the landscape position.

(9) In the above embodiments, the stand for holding the chassis with respect to an installation surface such as a floor surface is provided as a chassis support member. However, the present invention can be applied to one having a bracket for mounting the chassis to a vertical wall or a ceiling.

(10) In the above embodiments, the motors are used as power sources for the rotors. However, the rotors may be driven by power sources other than the motors.

(11) In the above embodiments, the chassis position is detected by the sensor. However, a person in the production or a user of the liquid crystal display device may manually drive the rotors according to the chassis position.

(12) The TFTs are used as switching components in the liquid crystal display device. The disclosed technologies can be applied to liquid crystal display devices that use switching components other than the TFTs, such as thin film diodes (TFDs). Furthermore, the technologies can be applied to black-and-white display devices other than color liquid crystal display devices.

(13) The liquid crystal display devices using the liquid crystal panels are used as examples in the above embodiments. However, the present invention can be applied to display devices using other types of display panels.

(14) The television receivers having tuners are used in the above embodiments. However, the present invention can be applied to display devices without tuners.

1. A lighting device comprising:
at least one discharge tube having electrodes at ends thereof and a luminescent material sealed therein;
a chassis having a bottom plate on an opposite side from a light output side with respect to the discharge tube and housing the discharge tube;
a chassis support member that holds the chassis such that a plate surface of the bottom plate is set along a vertical direction;
at least one discharge tube holder that holds the discharge tube in a position parallel to the plate surface of the bottom plate; and
a rotor configured to rotate the discharge tube around an axis perpendicular to the plate surface of the bottom plate with respect to the chassis.

2. The lighting device according to claim 1, wherein:
the discharge tube holder includes a fixed part fixed to the chassis in the mounting position and a movable part to which the discharge tube is mounted; and
the rotor includes a rotor shaft provided in any one of the fixed part and the movable part, and a shaft receiving portion provided in either one of the fixed part and the movable part in which the rotor shaft is not provided, the shaft receiving portion being configured to receive the rotor shaft and to enable a relative rotary movement of the movable part to the fixed part.

3. The lighting device according to claim 1, wherein:
the discharge tube holder includes a discharge tube mounting portion to which the discharge tube is mounted, and a rotor shaft projecting from the discharge tube mounting portion toward the bottom plate of the chassis;
the bottom plate of the chassis has a shaft hole into which the rotor shaft is inserted; and
the rotor includes a rotor shaft and a shaft receiving portion including a rim of the shaft hole and configured to receive the rotor shaft and to enable a relative rotary movement of the discharge tube holder to the chassis.

4. The lighting device according to claim 2, wherein the rotor shaft is mechanically connected to a motor that is a power source.

5. The lighting device according to claim 2, further comprising wires connected to an external circuit and the respective electrodes of the discharge tube, wherein the rotor shaft has an insertion hole through which the wires are pulled out to an outside, the insertion hole being a through hole formed concentric with the rotor shaft.

6. The lighting device according to claim 5, further comprising ferrules fitted onto the ends of the discharge tube and connected to the electrodes, wherein the discharge tube holder includes connecting terminals, each of which has a wire connecting portion at one end and a ferrule contact portion at another end, the ferrule contact portion being electrically connected to the corresponding ferrule.

7. The lighting device according to claim 1, wherein the rotor has a center of rotation around a midpoint of the discharge tube in an axial direction.

8. The lighting device according to claim 1, wherein the discharge tube is a straight-tube-type discharge tube.

9. The lighting device according to claim 1, wherein the discharge tube holder includes a grip part that holds the discharge tube.

10. The lighting device according to claim 1, wherein the at least one discharge tube and the at least one discharge tube holder include a plurality of discharge tubes and discharge tube holders, respectively, arranged in a matrix.

11. The lighting device according to claim 10, further comprising power transmission members connected to a motor that is a power source and to the respective discharge tube holders arranged in at least one of a row direction and a column direction on the bottom plate of the chassis at positions off the centers of rotation, wherein the discharge tube is rotated with a power transmitted through the power transmission members, the power being generated according to driving of the motor.

12. The lighting device according to claim 1, wherein the chassis support member and the chassis includes chassis rotor parts, respectively, for rotating the chassis around an axis perpendicular to the plate surface of the bottom plate with respect to the chassis support member.

13. A display device comprising:
the lighting device according to claim 1; and
a display panel configured to provide display using light from the lighting device.

14. The display device according to claim 13, wherein the display panel is a liquid crystal panel using liquid crystals.

15. A television receiver comprising the display device according to claim 13.
